(19) United States
(12) Patent Application Publication
(10) Pub. No.: US 2026/0202808 A1
(43) Pub. Date: Jul. 16, 2026

(54) DIGITAL RESCUE SHEET FOR BUILDINGS

(71) Applicant: ZF Friedrichshafen AG, Friedrichshafen (DE)

(72) Inventor: Stefan Traub, Friedrichshafen (DE)

(73) Assignee: ZF Friedrichshafen AG, Friedrichshafen (DE)

(21) Appl. No.: 19/138,924

(22) PCT Filed: Nov. 20, 2023
(86) PCT No.: PCT/EP2023/082315

§ 371 Date: Jun. 13, 2025

(30) Foreign Application Priority Data
Dec. 16, 2022 (DE) 10 2022 213 791.4

(51) Int. Cl. G05B 15/02

(52) U.S. Cl. CPC G05B 15/02

(57) ABSTRACT

A terminal device (101) having at least one input interface and at least one data transmission interface is configured to receive an identifier of a building (107) and information about structural conditions and/or sources of hazards in the building (107) via the input interface, to establish a data connection (109) to a central computer (105) via the data transmission interface, and to transmit the identifier with the information to the central computer (105) via the data connection (109).

### RELATED APPLICATIONS

This application claims the benefit under 35 U.S.C. § 371 as a U.S. National Phase Application of application no. PCT/EP2023/082315, filed on 20 Nov. 2023, which claims the benefit of German Patent Application no. 10 2022 213 791.4 filed on 16 Dec. 2022, the contents of which are hereby incorporated herein by reference in their entireties.

### FIELD OF THE DISCLOSURE

The invention relates to a terminal device according to the generic concept disclosed herein, to a terminal device, to a central computer, to methods for using such devices according to the methods disclosed herein, and to computer programs according to configured to execute methods disclosed herein.

### BACKGROUND

Analog rescue cards are known from the prior art. These contain vehicle-specific information that is relevant for rescue services in the event of an accident.

DE 10 2019 217 341 A1 discloses a digital rescue card. The vehicle-specific information is stored in digital form in the vehicle. In the event of an accident, the data can be transmitted via a radio connection to a mobile terminal device used by a rescue worker.

### SUMMARY

Rescue cards for buildings do not yet exist. Concepts known from the automotive sector are not suitable for use in buildings, as buildings are not mass-produced and therefore vary greatly from one another. As a result, rescue workers are constantly confronted with new floor plans and hazardous situations.

The invention is based on the task of providing better support to emergency services during rescue operations in buildings. In particular, the safety of such operations is to be improved.

This task is solved by a terminal device as variously disclosed herein, a central computer, methods, and computer programs disclosed herein. Numerous variations and embodiments will be apparent from the present disclosure.

The invention provides an arrangement with a building-side terminal device, a terminal device for rescue personnel, and a central computer. Such an arrangement makes it possible to collect building-specific information and make it available to the emergency services. Aspects of the invention relate accordingly to the building-side terminal device, the terminal device for rescue personnel, and the central computer.

A terminal device refers to a computer with one or more user interfaces and at least one display device The user interfaces are interfaces that can be operated by the user to receive user input. Output can be displayed in a form that can be evaluated by the user using the display device.

The terminal device in the building is a terminal device intended for use by a resident, administrator, or owner of a building.

The term “terminal device in the building” serves only to identify a terminal device in accordance with one aspect of the invention and does not imply any technical limitations beyond those implied by the term “terminal device”. The terminal device in the building is preferably intended for use by residents, an administrator, or an owner of a building.

The terminal device in the building has at least one input interface and at least one data transmission interface.

According to the invention, the terminal device in the building is designed to receive an identifier of the building and information on structural conditions and/or sources of hazards in the building via the input interface. In particular, it is possible for a user to enter the identifier and the information via a user interface, which forms the input interface. It is also possible to use a scanner as the input interface to scan information about hazardous substances located in the building.

The identifier refers to information that uniquely identifies the building. For example, the address or postal address or location coordinates of the building can be used as the identifier.

The information on structural conditions and/or sources of hazards may comprise any information that is relevant to emergency services during a rescue operation in or on the building. For example, the information may include a building plan, a floor plan, and/or floor plans of the building. An electrical plan, in particular a plan of photovoltaic systems installed in the building, may also be transmitted as part of the information. Information about dangerous pets, such as vicious dogs, or hazardous substances stored in the building should also preferably be included in the information transmitted. In addition, photos and/or videos of sources of hazards may be included in the information.

The terminal device establishes a data connection to a central computer via the data transmission interface. This preferably takes place after the terminal device has received the identifier and the information via the input interface.

The terminal device transmits the identifier with the information to the central computer via the data connection.

The terminal device for emergency services has at least one input interface, at least one data transmission interface, and at least one display device. It is used to receive and display the identifier of a building previously transmitted to the central computer together with the associated information, i.e., information about the structural conditions and/or sources of hazards in that building, so that this information is available to emergency personnel during a rescue operation in or at the building.

According to the invention, the terminal device for emergency services is designed to receive a building identifier via the input interface. This allows the identifier of the building in or on which a rescue operation is taking place to be entered via the input interface.

A data connection to the central server can be established via the data transmission interface. The previously entered identifier is transmitted to the central computer via this data connection. In response, the central computer sends previously stored information about the structural conditions and/or sources of hazards in the building via the data connection. The transmitted information is received by the terminal device and displayed by means of the display device.

The terminal device in the building and/or the terminal device for emergency services is preferably designed to establish the data connection automatically, i.e. without user intervention. In particular, the data connection can be established by the respective terminal device, i.e. initiated by the respective terminal device. The data connection is preferably established in response to the receipt of the identifier and, if applicable, the associated information. Preferably, the identifier and, if applicable, the associated information is also automatically transmitted to the central computer via the data connection.

In a preferred further development, a user interface and/or a scanner forms the above-mentioned input interface of the terminal device in the building and/or the terminal device for emergency services. Using the user interface, a user, such as a resident, administrator, or owner of the building or an emergency service personnel, can enter the identifier and, if necessary, the associated information into the respective terminal device. Hazard warnings can be scanned using the scanner. For example, warnings affixed to containers for hazardous substances can be scanned.

The terminal device in the building and/or the terminal device for emergency services is preferably designed as a mobile terminal device. A mobile terminal device refers to a portable terminal device that is not tied to a specific location. Smartphones are particularly suitable as mobile terminal devices.

The central computer acts as an intermediary between terminal device in the building and terminal devices for emergency services. It stores the identifiers transmitted by the terminal device in the building together with the associated information and transmits them to a terminal device for emergency services as required. The information to be transmitted is requested via a terminal device for emergency services, as described above, by transmitting the identifier of a building in which a rescue operation is taking place to the server. In response, the server transmits the associated information to the terminal device for emergency services.

To store the identifiers and information, the central computer has a corresponding data structure according to the invention. Specifically, it is designed to store identifiers of buildings and the associated information on structural conditions and/or sources of hazards of the respective building in the data structure

The data structure is characterized by the fact that it assigns the relevant information to each identifier. This makes it possible to retrieve the information as required using the respective identifier.

In preferred further developments, the central computer has at least one data transmission interface. This is used to enable data connections to the data transmission interfaces of terminal devices in the building.

The central computer has been upgraded to receive the identifiers and associated information via the data connections. Specifically, the upgrade provides for the identifiers and associated information to be entered via terminal devices in the building and transmitted to the central computer via the data connections. Alternatively, or in addition to this, it is possible to link the central computer to a database for building applications and transfer the relevant data to the central computer.

In a further preferred embodiment, the data transmission interface of the central computer is used for communication with terminal devices for emergency services. Accordingly, the central computer is further developed to enable data connections with corresponding data transmission interfaces of terminal devices for emergency services via its data transmission interface.

Specifically, the central computer has been upgraded to receive a building identifier via such a data connection. This identifier identifies a building where a rescue operation is taking place. In accordance with the further development, the central computer reads the relevant information, i.e., the information on the structural conditions and/or sources of hazards of the building, from the data structure and transmits it to the terminal device via the data transmission connection.

In the event of a hazard, gas and smoke detectors can be linked to the data on the digital rescue card to provide important information directly to the emergency services. To do this, the gas and smoke detectors must be connected to the Internet and can be assigned to the respective building and room via unique identifiers.

The behavior of the terminal device in the building described above constitutes a method according to the invention. A computer program according to the invention is designed to be executed on such a terminal device. It contains instructions which cause the terminal device to behave in this way when executed.

The behavior of the terminal device for emergency services described above also constitutes a method according to the invention. A computer program according to the invention is designed to be executed on such a terminal device. It contains instructions that cause the end device to behave in this way during execution.

Finally, the behavior of the central computer according to the invention described above is a method according to the invention. A computer program according to the invention is designed for execution on the central computer. It contains instructions which cause the central computer to behave in this way during execution.

### BRIEF DESCRIPTION OF THE DRAWING

A preferred exemplary embodiment of the invention is shown in the sole figure, FIG. 1. In detail, which shows:

FIG. 1: a dispatch system.

### DETAILED DESCRIPTION

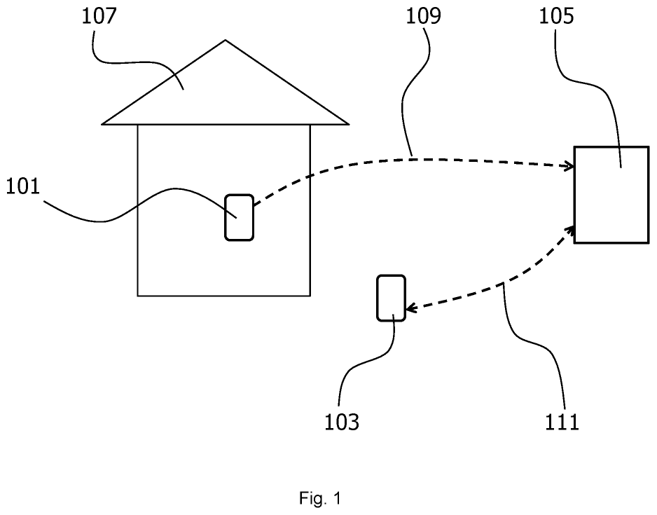

The dispatch system shown in FIG. 1 implements a digital rescue map. It comprises a terminal device in the building 101, a terminal device for rescue personnel 103, and a central computer 105.

The terminal device in the building 101 is used in a building 107. It serves to transmit an identifier of the building 107 and information relevant to the operation to the central computer 105 via a data connection 109 between the terminal device in the building 101 and the central computer 105.

The central computer 105 stores the data received via the data connection 109 in a data structure. The data structure is designed in such a way that it enables the central computer 105 to access the relevant information for the operation using the identifier.

The terminal device for rescue personnel 103 is used to provide an emergency responder with the aforementioned information relevant to the operation during a rescue operation at or in the building 107. To do this, the emergency responder first enters the identifier of the building 107 into the terminal device 103. This identifier is transmitted to the central computer 105 via a data connection 111 between the terminal device for rescue services 103 and the central computer 105. The operations computer 105 reads the relevant information from the data structure and transmits it via the data connection 111 to the terminal device 103 for emergency services. The terminal device 103 displays the transmitted information to the emergency services.

The data transmitted via data connections 109 and 111 is encrypted. This prevents misuse of the data. In particular, it prevents third parties, such as potential burglars, from drawing conclusions about building 107.

### REFERENCE NUMBERS

101 Terminal device
103 Terminal device
105 Central computer
107 Building
109 Data connection
Data connection

1. A terminal device (101) having at least one input interface and at least one data transmission interface, wherein the terminal device (101) is configured to receive an identifier of a building (107) and information about structural conditions and/or sources of hazards in the building (107) via the input interface, to establish a data connection (109) to a central computer (105) via the data transmission interface, and to transmit the identifier with the information to the central computer (105) via the data connection (109).

2. A terminal device (103) having, comprising:
at least one input interface;
at least one data transmission interface; and
at least one display device, wherein the terminal device (103) is configured:
to receive an identifier of a building (107) via the input interface,
to establish a data connection (111) to a central computer (105) via the data transmission interface,
to transmit the identifier to the central computer (105) via the data connection (111),
to receive information about structural conditions and/or sources of hazards in the building from the central computer (105) via the data connection (111), and
to display the information by means of the display device.

3. The terminal device (101, 103) according to claim 2, wherein the terminal device (101, 103) is configured to automatically establish the data connection (109, 111).

4. The terminal device (101, 103) according to claim 2, wherein a user interface and/or a scanner of the terminal device (101, 103) forms the input interface.

5. The terminal device (101, 103) according to claim 2, wherein the terminal device (101, 103) is configured as a mobile terminal device.

6. A central computer (105); configured to store identifiers of buildings and information on structural conditions and/or sources of hazards of the respective building in a data structure which assigns the associated information to each identifier of a building.

7. The central computer (105) according to claim 6, comprising one data transmission interface; wherein the central computer (105) is configured to receive the identifiers and associated information via data connections (109) between its own data transmission interface and in each case one data transmission interface of a terminal device (101) according to claim 1.

8. The central computer (105) according to claim 7, comprising one data transmission interface; wherein the central computer (105) is further configured to receive an identifier of a building via a data connection (111) between its own data transmission interface and the data transmission interface of a terminal device (103) according to claim 2, read the associated information from the data structure and transmit it via the data connection (111) to the terminal device (103).

9. A method for using a terminal device comprising:
providing the terminal device of claim 1;
receiving an identifier of a building and information on structural conditions and/or sources of hazards in the building via the input interface;
establishing a data connection (109) to a central computer (105) via the data transmission interface; and
transmitting the identifier and the information to the central computer (105) via the data connection (109).

10. A computer program product having machine-executable code configured for execution on the terminal device (101) according to claim 1; wherein the machine-executable code comprises instructions that cause the terminal device (101) to execute the following method:
receiving an identifier of a building and information on structural conditions and/or sources of hazards in the building via an input interface:
establishing a data connection (109) to a central computer (105) via a data transmission interface; and
transmitting the identifier and the information to the central computer (105) via the data connection (109).

11. A method for using the terminal device according to claim 2, the method comprising:
receiving an identifier of a building (107) via the input interface,
establishing a data connection (111) to a central computer (105) via the data transmission interface,
transmitting the identifier to the central computer (105) via the data connection (111),
receiving information about structural conditions and/or sources of hazards in the building via the data connection (111), and
displaying the information by means of the display device.

12. A computer program product having machine-executable code configured for execution on the terminal device (103) according to claim 2, the machine-executable code comprising instructions that, when executed, perform the following method:
receiving an identifier of a building (107) via the input interface;
establishing a data connection (111) to a central computer (105) via the data transmission interface;
transmitting the identifier to the central computer (105) via the data connection (111);
receiving information about structural conditions and/or sources of hazards in the building via the data connection (111); and
displaying the information by means of the display device.

13. A method for using a central computer (105) according to claim 6, comprising:
storing identifiers of buildings and information on structural conditions and/or sources of hazards of the respective building in a data structure which assigns the associated information to each identifier of a building.

14. A computer program product having machine-executable code configured for execution on the central computer (105) according to claim 6, the machine-executable code comprising instructions that cause the central computer (105) to execute the following method:
storing identifiers of buildings and information on structural conditions and/or sources of hazards of the respective building in a data structure which assigns the associated information to each identifier of a building.
